(19) United States
(12) Patent Application Publication
(10) Pub. No.: US 2019/0026659 A1
(43) Pub. Date: Jan. 24, 2019

(54) SYSTEM, METHOD AND MEDIUM FOR WORKPLACE ALLOCATION AND RESERVATION IN A COMMERCIAL ESTABLISHMENT

(71) Applicant: Sergey Yakubovich, Ashkelon (IL)

(72) Inventor: Sergey Yakubovich, Ashkelon (IL)

(21) Appl. No.: 16/044,048

(22) Filed: Jul. 24, 2018

Related U.S. Application Data
(60) Provisional application No. 62/536,223, filed on Jul. 24, 2017.

(51) Int. Cl. G06Q 10/02; G06Q 10/06; G06Q 50/00

(52) U.S. Cl. CPC G06Q 10/02; G06Q 50/01; G06Q 10/0631

(57) ABSTRACT

A computer implemented method, system and medium for assisting users to perform workplace allocation and reservation in commercial establishments, and private residences and properties, is disclosed. The present invention includes an electronic communication device having a processor to execute a number of instructions of an application configured to perform a variety of tasks including: enabling service providers to publish available workspaces in commercial establishments, and private residences and properties, for utilization by customer as workspaces, and allowing the users to search by geographic location and/or address, request and book one or more workspaces for a specific date, time, and duration. Service providers may also post: a layout of at least one seating arrangement associated with the venue; a plurality of specialized offers to the customers; and/or additional services including a food, beverages, a Wi-Fi devices and other connectivity devices.

### CROSS-REFERENCE TO RELATED APPLICATION

This application claims priority to U.S. provisional patent application Ser. No. 62/536,223, filed Jul. 24, 2017, and titled “System, Method and Application for Workplace Allocation and Reservation in a Commercial Establishment”, the entire contents of which are hereby incorporated by reference in their entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### TRADEMARKS DISCLAIMER

The product names used in this document are for identification purposes only. All trademarks and registered trademarks are the property of their respective owners.

### FIELD OF THE INVENTION

The present invention generally relates to a computer system, method, and medium for space booking workspace allocation in a commercial establishment. More specifically, the present invention relates to a computer system, method, and medium for enabling service providers of commercial establishments and private residences to post available seating locations, and customers to reserve the seats for a temporary period of time to perform office and desk related work (e.g. computer work where customer may bring own computer and venue provides free Wi-Fi, and reading and writing work) and meetings.

### BACKGROUND OF THE INVENTION

Customarily, guests ask for booking at a commercial establishment such as restaurant, café, hotels etc. by phone, email, and/or online for a specific date, time and/or table. The operator at the restaurant and/or any other business entity books a specific number of seats as per the requirement by the user or the customer. When using a phone call method to make the booking, the restaurant may inform the guest or the customer if the table is available and/or place the customer on a waiting list. A few disadvantages of this method are such that the customer may dial the wrong phone number, there may be a language barrier between the customer and the business entity, and/or there may be human error in entering the wrong date and/or time of the booking. Most of the time, the customer will not be informed about the current waiting list status and the chance to get the requested number of seats.

With the advancement in Internet and electronic communications devices (e.g. smartphones, tablets, etc.) the searching, selection and booking of physical services such as restaurant booking, café seat booking, travel ticket booking etc. are done through online platforms. The existing online systems and services allows customers to select the exact seat or seats they want for any type of event or reserve an appointment for any activity such as dining, hangout, playing, travelling, etc. The customers can search for available spaces or seating positions from a list of places and select desired number of seats at a desired time and place and order the exact seat or seats or the time of his/her choosing directly online. The seat or seats or reserved time he/she selects is then removed from the inventory for that activity or event and made not available for any other customer, and such is so indicated by a graphical representation or other such indicator on the online map or picture representing availability of seating or time for that event.

However, there are no such online platforms exists that allow the owners of commercial establishments and private residences to list their available space for work related, professional and personal matters. Moreover, the existing online platforms do not allow customers to search for available spaces in commercial establishments and private residences for work related, professional and other matters. There are several prior arts that allow the users to perform online booking in commercial establishments such as restaurants, cafes, hotels etc. However, all such platforms failed to provide a means that allow the professionals and other people who wish to work out-of-the-office and home to find a suitable space for desktop, office, and computer related work with Wi-Fi connections in addition to the usual service offered by the commercial establishments such as restaurants, cafes, hotels etc. One such application is US 20170098174 A1 titled “System and Method for Utilizing Restaurant Services” filed by Prasad Venigalla, which provides a system and method designed to increase the operating efficiency of a restaurant by decreasing the customer waiting times during the dining experience. Here an application software is utilized by both the restaurant and patrons over a computer network. The application software creates reservations for patrons on selected dates and at selected times. However, the above prior art does not disclose a means for online workspace allocation and reservation of the workspaces in commercial establishments.

Another prior art US 20130090959 A1 titled “Restaurant management and reservation systems and methods” offers similar features as the above listed prior art, by offering and managing reservations for restaurants, or other reservation-based services. This method includes the steps of receiving reservation data regarding available reservations for restaurants, matching the search request against the subset of the available reservations for determining the open reservation data, etc. However, the above prior art does not disclose a means for online workplace allocation and reservation of the workplace in commercial establishments.

Another prior art WO 2016063295 A2 titled “Platform for helping people meet for various purposes” provides a platform based on software technology to help individuals to meet in realtime and thus break the virtual meet divide on the internet. The platform assists individuals to meet other individuals for social, religious, business, recreational, dating and other purpose and the platform can be utilized by them to find and meet such individual or group in realtime by booking a place to meet, or a designated place to meet through mutual concern. However, the above prior art does not disclose a means for online workplace allocation and reservation of the workplace in a commercial establishment or private residence by users who want to conduct a work-related meeting, and/or perform desktop related work (e.g. bringing their own laptop computer, and/or writing material, and/or reading material), away from home and office space.

Hence, it can be seen that there is a need for a system, method and medium for an online social networking platform that provides a variety of services including advertising and booking online workplace allocation by commercial establishments and private residences. The needed system would enable service providers representing commercial establishments and private residences (e.g. venue owners, managers, designated employees, etc.) to post available workspaces in their establishments; and allow the customers to view and review the available workspaces in real-time, and make a reservation online for it through the online platform. Moreover, the needed system would allow the customers to communicate with the commercial establishments and private residences, and would get updated information about the availability of the workspaces in the commercial establishments.

### SUMMARY OF THE INVENTION

In view of the foregoing disadvantages inherent in the known types of systems like in the prior art, the present invention provides a computer implemented system and method and medium for assisting users to perform workplace allocation and reservation in a venue comprising a commercial establishment, a private residence, and a private property. The system includes an electronic communications device having a processor to execute a number of instructions of an application configured to perform a variety of tasks including enabling the commercial establishments and private residences to publish a plurality of available spaces for utilization by customers and allowing the customers to request one or more space associated with the commercial establishment or private residence at a predetermined date for a predetermined period of time. The space can be utilized for work related and other professional related matters, such as business meetings and job interviews. The system further includes a server running a server-side application associated with the application running on the electronic communication device and a communication network for enabling communication between the server and the electronic communication device. The application running on the electronic communication device allows the commercial establishments and private residences to publish the available spaces to the users through a dynamic graphical user interface of the application in real-time for enabling the users to select a desired space for personal and professional engagements including work related matters.

The present invention further comprises computer methods, and non-transitory computer readable storage medium containing executable instructions for enabling at least one customer to perform a search and booking of the workspace; and may further comprise instructions for at least one service provider to post at least one, or a plurality of available workspaces. The executable instructions include instructions for: the computer receiving customer input for, or allowing a customer to register with a networked computer system, and then search for available space in a commercial establishment, and/or a private residence and property, in a particular location or a place for work. The instructions further comprise: the computer receiving customer user input for, or allowing the user to book the space, and create and share content about the space.

Other features and other main objectives of the present invention are discussed below. The present invention is designed to fulfill the below and other additional objectives as detailed in the following claims section and detailed description section of the invention.

A primary objective of the invention is to provide a networked computer system for assisting a service provider of a commercial establishment and/or private residence to perform workplace allocation to the public through an online platform.

Another objective of the present invention is to provide a computer-implemented system for assisting customers (e.g. working professionals) to reserve one or more desired seating or working positions in the commercial establishment.

A third objective of the present invention is to provide non-transitory computer storage medium having a number of executable instructions by a processor of an electronic communication device to perform the above said objectives.

A fourth objective of the present invention is to provide an electronic communications device with memory and a processor, and comprising (e.g. having installed thereon) an application having a dynamic graphical user interface capable of displaying a variety of information including: available spaces in a commercial establishment for utilization by the customers for work and other professional tasks; availability of office devices or equipment (computers, Wi-Fi, printers, scanners, landline phones, projector screens, etc.) that can be utilized by the customers; and the real-time status view of the available spaces and equipment and advanced booking services, upon processing of the instructions of the application by the processor associated with the electronic communication device.

Another objective of the present invention is to provide one or more servers in communication with the electronic communication devices running the application for workplace allocation and reservation for managing the booking, user (service providers and customers) information and coordinating the operation of the application running on the electronic communication devices.

A sixth objective of the present invention is to provide a server running a server-side application capable of communicating with the application running on the electronic communication devices for workplace allocation and reservations.

A seventh objective of the present invention is to provide the workplace allocation and reservation application in a variety of formats including mobile application, web application and a cloud-based application.

An eighth objective of the present invention is to provide an application accessible from the electronic communication devices to allows the customers to search for the available spaces associated with the commercial establishments and private residences for work and other professional meetings and interviews.

Another objective of the present invention is to provide an application having a dynamic graphical user interface to allow the customers to provide a variety of information including a desired location of the commercial establishment, a desired duration and date of use, a number of spaces required, a number of additional services including a food, beverages, connectivity equipment including Wi-Fi devices and other computer, communications, and office devices and equipment for utilization and a location of a seating space in the commercial establishment.

A tenth objective of the present invention is to allow a variety of service providers including private residences and property, and commercial establishments, such as restaurants, hotels, cafes, office spaces, hangout places, and other commercial entities (e.g. empty office buildings) offering space and necessary equipment for interviews, meetings, business dining, working and other personal and professional engagements to register as a service provider through the dynamic graphical user interface of the application.

Another objective of the present invention is to provide the application having a dynamic graphical user interface that allows the users to register in form of a customer and/or a service provider.

Another objective of the present invention is to provide the application having a dynamic graphical user interface that allows the service providers to provide a variety of data including a location of their private residence or property, and/or commercial establishment, services offered to the customers, layout of the seating arrangement, specialized offers that can be given to the customers and a real-time status of the available space for the customers.

Another objective of the present invention is to provide an application that would allow the customers to search for the available spaces for extended working (operating) hours, and professional engagements (e.g. meetings, interviews, dining or drinks, presentations) within a geographic area, or by an address, of interest through the dynamic graphical user interface of the application.

Yet another objective of the present invention is to provide a dynamic location map and the available spaces in commercial establishments and/or private residences and property for work, meetings, business dining and other personal and professional engagements through the dynamic graphical user interface of the application.

Another objective of the present invention is to provide an application that would receive notifications and advertisements to alert the customers regarding user specific or personalized promotional offers from service providers.

Another objective of the present invention is to provide an application that would allow the service providers to provide profitable deals for the users based on factors including customer demand, time, duration of use, date of use, and other external factors.

Yet another objective of the present invention is to provide an application that would allow the users to search for spaces in commercial establishments at a desired location, compare a number of deals for the available spaces, view a layout of the space in the commercial establishment or private residence, book the space for a predetermined date and for a predetermined duration and book a variety of services from the commercial establishment or private residence.

Another objective of the present invention is to provide an application that would allow the customers to provide feedbacks to the booking through the dynamic graphical user interface.

Yet another objective of the present invention is to provide an application that can form a social networking platform to connect a number of customers and/or service providers registered to the application.

Another objective of the present invention is to provide an application that would to allow the users to share his/her location through the dynamic graphical user interface to notify and invite others for meetings and other professional engagements.

Another objective of the present invention is to provide an application that would to allow the users to share information regarding his/her activity, such as, location, project and work details, meeting topics, and other relevant information on the activity performed at the commercial establishment at the commercial establishment and/or private residence or property to notify and invite others.

Another objective of the present invention is to provide an application that would allow the customers to form social connections through the dynamic graphical user interface to interact and to enable personal and professional interactions.

Another objective of the present invention is to provide an application to allow the customers to communicate through a real-time chat feature through the dynamic graphical user interface of the application.

Yet another objective of the present invention is to provide an application that would allow the customers to work privately or share workspace by changing his/her visibility through the dynamic graphical user interface of the application.

Another objective of the present invention is to provide an application that would allow the customers to receive rewards and loyalty points for expanding and forming new social connections through the dynamic graphical user interface of the application.

Yet another objective of the present invention is to provide an application that would allow the customers to book a workspace comprising seating at a desk or table or cubicle, and may further comprise free internet and/or power outlet availability.

The present invention further comprises a computer program product comprising a non-transitory computer readable storage medium having computer readable program code embodied therewith that is configured to perform the methods disclosed herein of service providers posting workspaces and user-customers booking the spaces for a particular time and date.

An electronics communication device comprising a memory, the application disclosed herein installed in memory, or accessible online, a graphical user interface or display, a wireless or wired connection, and a processor configured to: to perform the methods disclosed herein of service providers posting workspaces and customers searching for, and booking the spaces for a particular time, date, and duration.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 illustrates a block diagram showing the different functional blocks of the present system for online workplace allocation and reservation of the available workplaces in commercial establishments, according to a preferred embodiment of the present disclosure.

FIG. 2 is a block diagram showing the different components and modules of the electronic communication device running the application for managing the workplace allocation and reservation of the available workspaces in a commercial establishment, according to a preferred embodiment of the present invention.

FIG. 3 is a block diagram showing the different components and modules of the server in communication with the electronic communication device running the application for managing the workplace allocation and reservation of the available workspaces in a commercial establishment, according to a preferred embodiment of the present invention.

FIG. 4A illustrates a welcome page user interface of the application for managing the workplace allocation and reservation of the available workspaces in a commercial establishment, according to an embodiment of the present invention.

FIG. 4B illustrates a new user registration interface of the application for managing the workplace allocation and reservation of the available workspaces in a commercial establishment, according to an embodiment of the present invention.

FIG. 4C illustrates a social media integration user interface of the application for managing the workplace allocation and reservation of the available workspaces in a commercial establishment, according to an embodiment of the present invention.

FIG. 4D illustrates a service provider registration user interface of the application for managing the workplace allocation and reservation of the available workspaces in a commercial establishment, according to an embodiment of the present invention.

FIG. 4E illustrates a layout provided by a service provider accessible through a user interface of the application for managing the workplace allocation and reservation of the available workspaces in a commercial establishment, according to an embodiment of the present invention.

FIG. 4F illustrates a messaging and communication user interface of the application for managing the workplace allocation and reservation of the available workspaces in a commercial establishment, according to an embodiment of the present invention.

FIG. 5 is a flowchart showing the steps for a user to perform bookings in a commercial establishment through the application for workplace allocation and reservation in commercial establishments, according to a preferred embodiment of the present invention.

### DETAIL DESCRIPTION OF THE INVENTION

### Glossary of Terms

As used herein, a “computer system” may refer to a networked system having one or more computers, where each computer may include non-transitory computer-readable storage medium embodying software to operate the computer or one or more of its components. Non-limiting examples of a computer system may include: a distributed computer system for processing information via computer systems linked by a network; and, two or more computer systems connected together via a network for transmitting and/or receiving information between the computer systems.

As used herein, the term “processor” may refer to any device or portion of a device or apparatus that processes electronic data from registers and/or memory to transform that electronic data into other electronic data that may be stored in registers and/or memory. A “computer system” may comprise one or more processors.

As used herein, the term “computer-readable storage medium” or “computer-readable medium” refers to any medium that participates in providing data (for example, instructions), which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G. The present invention further comprises a non-transitory computer-readable storage medium that comprises executable instructions to define a processor to perform the methods disclosed herein, e.g. receiving workspace availability in venues and booking reservations for them.

As used herein, the term “Application” and/or “Software” refer to all, or a portion, of a computer program or software code that carries out a specific function and may be used alone or combined with other programs. It comprises computer program instructions adapted for execution by a hardware element, such as a processor, wherein the instruction comprise commands that when executed cause the processor to perform a corresponding set of commands. The software may be written or coded using a programming language, and stored using any type of non-transitory computer-readable media or machine-readable media well known in the art. Examples of software in the present disclosure comprise any software components, programs, applications, computer programs, application programs, system programs, machine programs, and operating system software.

Examples of software code in applications may include: code segments in one or more computer-readable languages; graphical and or/textual instructions; applets; pre-compiled code; interpreted code; compiled code; and computer programs. Computer program code for carrying out operations for aspects of the various embodiments may be written in any combination of one or more programming languages, such as: an object oriented programming languages and/or conventional procedural programming languages, and/or programming languages such as, for example, Hypertext Markup Language (HTML), Dynamic HTML, HTML5, Extensible Markup Language (XML), Extensible Style sheet Language (XSL), Document Style Semantics and Specification Language (DSSSL), Cascading Style Sheets (CSS), Synchronized Multimedia Integration Language (SMIL), Wireless Markup Language (WML), JAVA; JavaScript, JINI, C, C++, Objective C or any language operable on a wireless platform like iOS, Ruby, Ruby on Rails, Perl, UNIX Shell, Visual Basic or Visual Basic Script, Virtual Reality Markup Language (VRML), ColdFusion™; Adobe Flash & related languages; or other compilers, assemblers, interpreters or other computer languages or platforms.

As used herein, the term “Electronic Computing Device” or “Electronic Communication Device” refers to a device comprising at least one processor, memory, and a graphical user interface (GUI) or display, such as a smartphone, laptop, desktop, tablet, etc., as well as any device defined herein as a “computer”.

As used herein, the term “Graphical User Interface” refers to all the visually identifiable and/or intractable visuals displayed through a display of the electronic computing-communications device.

A “client-side” application may refer to an application, a page associated with that application, or some other resource or function invoked by a client-side request to the application.

A “server-side” application may refer to an application running on the server in communication with the “Electronic Computing Device” or the “Electronic Communication Device” and is cable of exchanging, storing and processing data received from the client-side application running on the “Electronic Computing Device” or the “Electronic Communication Device”.

A “browser” as used herein is not intended to refer to any specific browser (for example, Internet Explorer, Safari, Firefox, or the like), but should be broadly construed to refer to any client-side rendering engine that can access and display Internet-accessible resources. A “rich” client typically refers to a non-HTTP based client-side application, such as an SSH or CFIS client. The client-server interactions may occur using HTTP or other protocols. The client server interaction may be formatted to conform to the Simple Object Access Protocol (SOAP) and travel over HTTP or any other transport mechanism (such as CORBA, for transport over an enterprise intranet) may be used. Any application or functionality described herein may be implemented as native code, by providing hooks into another application, by facilitating use of the mechanism as a plug-in, by linking to the mechanism, and the like.

As used herein, the term “network” or “communication networks” may operate with any of a number of protocols, wireless, Wi-Fi, and such as Internet protocol (IP), asynchronous transfer mode (ATM), and/or synchronous optical network (SONET), user datagram protocol (UDP), IEEE 802.x.

As used herein “venues” refers to commercial entities, and/or private residences and/or private properties that in the present invention are reserved for at least one work space (e.g. hourly rental for a specific time and date). Commercial entities comprise established businesses (e.g. within zoning areas and registered as “businesses”), such as restaurants, hotels, cafes, office spaces, hangout places, and other commercial entities offering work spaces, e.g. computer work, desk work, professional meetings, interviews, and presentations and professional meals or drinks. Private residences and property comprise buildings normally used and/or zoned for private use, and comprising at least one room suitable for work spaces, e.g. computer work, desk work, professional meetings, interviews, etc. Non-limiting examples of private residences and property comprise: houses, apartments, duplexes, cottages, guest houses, cabins, converted/remodeled garages, converted/remodeled storage buildings, etc.

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The following embodiments and the accompanying drawings, which are incorporated into and form part of this disclosure, illustrate one or more embodiment of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

The present invention relates to online services and applications offering services including online workplace allocation and reservation of a workplace in a venue comprising a commercial establishment and/or a private residence and/or a private property. The present invention further relates to a system and associated method for online workplace allocation and reservation of available workplaces in commercial establishments. The present system includes a web application or a software application or a mobile application that can be used by both commercial establishments and private residences and property, such as, but not limited to: office spaces, commercial places, public workplaces and privately property that provides seating arrangements to customers, hotels, restaurants, café s, hangout places, etc. and by the consumers or professionals who wants to book a desired location for work, meetings, professional engagements, other device or equipment for work etc. The commercial establishments and private residences and property are allowed to publicize their facilities and to provide a layout of seating arrangements and other information, such as real-time seating availability information, advanced booking features, promotional offers, special offers for loyal clients, etc. through a dynamic graphical user interface of the application launched from the electronic communication device of the service provider, such as the owners of the commercial establishments and private residences and property. The application can further be used by other people such as, but not limited to, professionals, or other people who are looking for a place to work, for other work related or other professional engagements away from home and their office space. The present system and associated application provides dynamic real-time updated information about a particular commercial location, hangout place, commercial place such as a particular café or restaurant or hotel to the users. Further the application allows the service providers such as, but not limited, to the restaurant owners to provide a seating layout of the place so that the users are allowed to interact with the layout arrangements through the dynamic graphical user interface of the application. The users can also search for a desired place at a desired location and can pre-book for hours, or parts of hours (e.g. half hour blocks of time) the seating position(s) or places.

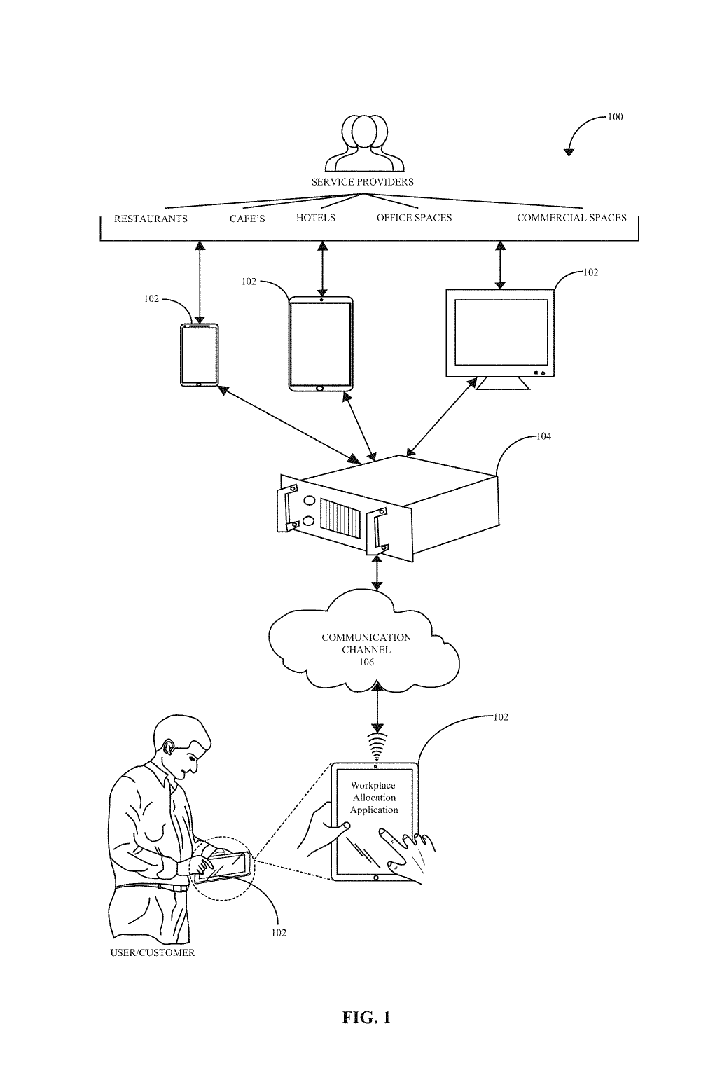

FIG. 1 illustrates a block diagram showing the different functional blocks of the present system 100 for online workplace allocation and reservation of the available workplaces in commercial establishments, according to a preferred embodiment of the present invention. The present computer implemented system 100 for assisting the users to perform bookings in the commercial establishments includes electronic communication devices 102 capable of launching or running the application for online workplace allocation and reservation, one or more servers 104 in communication with the electronic communication devices 102 and a communication network 106 enabling real-time communication between the application running on the electronic communication devices 102 and the server 104. In some instances, the server 104 runs a server-side application complementary or configured to directly communicate with the application running on the electronic communication devices 102 of the users. The users can launch the application from within the electronic communication devices 102 to register in form of a commercial establishment and private residences and property offering space to customers, or as a customer requiring services including space for work and other work-related tasks (e.g. meetings, interviews, etc.) and professional engagements.

In certain embodiment, the application for managing the workplace allocation and reservation of the available workspaces in a commercial establishment and private residences and property is available in form of a mobile application, desktop or web application and a cloud-based application that can be accessed by the users through the electronic communication device 102. In some instances, the application is available in application stores such as, but not limited to, App store and Play Store® and the users are allowed to download and install the application from the application stores over the Internet in their electronic communication devices 102. The application in such cases are further configured to run on a variety of electronic communication devices 102 such as, but not limited to, smartphones, tablets, other wearable smart electronic devices, etc. In some other instances, the application is made available to be run on electronic communication devices 102 such as, but not limited to, normal desktop computers and laptops. In some other instances, the application for managing the workplace allocation and reservation of the available workspaces in a commercial establishment is accessible to the users in form of a web application through the web browsers of the electronic communication devices 102. In another instance, the application managing the workplace allocation and reservation of the available workspaces in a commercial establishment is run on a cloud platform and the users are allowed to access the application from the cloud platform using the electronic communication devices 102 of the user.

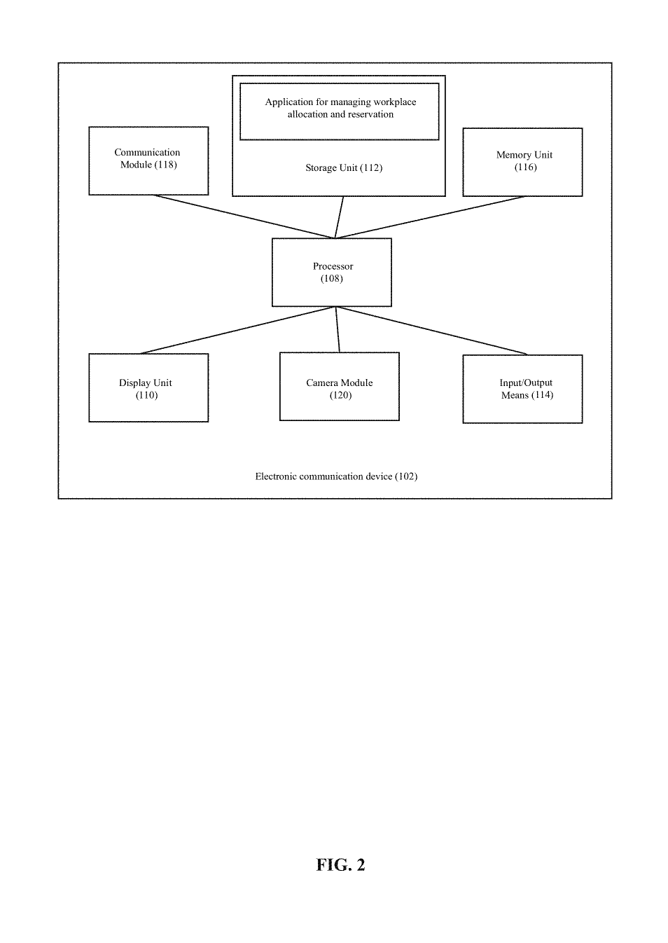

The hardware and software components of the present system 100 are discussed in detail below prior to disclosing the unique features and services offered by one or more embodiment of the present system 100. FIG. 2 is a block diagram showing the different components and modules of the electronic communication device 102 running the application for managing the workplace allocation and reservation of the available workspaces in a commercial establishment, according to a preferred embodiment of the present invention. The electronic communication device 102 can be any smart device such as, but not limited to, a smartphone, tablet, desktop or laptop computer, smart wearable devices, and other smart devices or a computer connected to the Internet and capable of displaying a dynamic graphical user interface (GUI) of the application for managing the workplace allocation and reservation of the available workspaces in a commercial establishment. The electronic communication device 102 includes a processor 108 to process a number of instructions of the application, which enable the commercial establishments and private residences and property to publish available spaces for utilization by the users, allow the customer-users to request one or more spaces associated with the commercial establishment and private residences and property, and listed through the dynamic graphical user interface of the application at a predetermined date for a predetermined period of time for tasks such as, but not limited to, work and other work related tasks and professional engagements. However, the commercial establishments listing the available space may also provide additional services such as, but not limited to, food, beverages, privacy, noise-control, and other services, to the users. The electronic communication device 102 further includes a display unit 110 for displaying the dynamic graphical user interface of the application, a storage unit 112 for storing a variety of data including contents shared or received through the application, an input/output means 114 for allowing the users to interact with the dynamic graphical user interface of the application, a memory unit 116 for temporarily storing the data and instructions while performing a number of operations by the processor 108 based on the instructions of the application and a communication module 118 to enable communication between the electronic communication devices 102 and the server 104 via the communication network 106. The users are allowed to interact with the contents presented on the dynamic graphical user interface of the application using a keyboard, pointing device such as a mouse, at least one gesture or touch, voice activation, or any other interacting means. The electronic communication devices 102 further includes a camera module 120 to capture the contents including images and videos and share the captured contents through the dynamic graphical user interface of the application. Further, the input/output means 114 allows the users to respond or react to the contents presented through the dynamic graphical user interface of the application using text, voice i.e. as audio response or audio comments, pictures, videos or special characters such as, but not limited to, emojis and other symbols. Further the input/output means 114 allows the users to view or listen to the reactions or responses from other users (e.g. customers) on the contents presented through the dynamic graphical user interface of the application for managing the workplace allocation and reservation of the available workspaces in a commercial establishment.

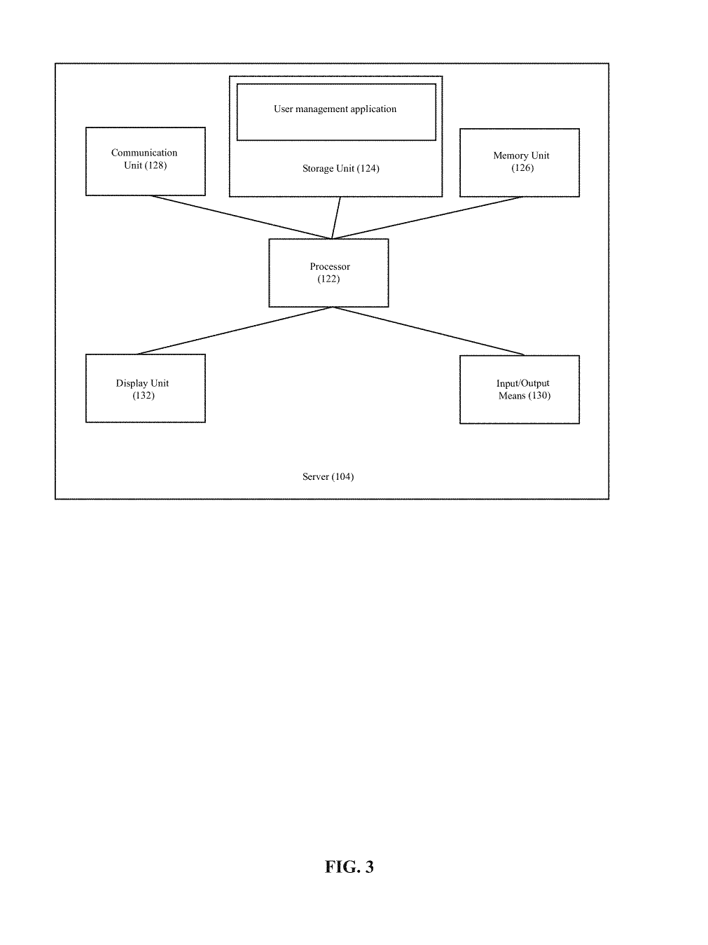

According to a preferred embodiment of the present system 100, all the communication between the applications for managing the workplace allocation and reservation of the available workspaces in a commercial establishment running on the electronic communication devices 102 of the users are performed through the server 104 over the communication network 106. The server 104 can be a physical server 104 located at one or more locations or a central cloud server 104 offering services to the users via the application connected to the central cloud server 104. FIG. 3 is a block diagram showing the different components and modules of the server 104 in communication with the electronic communication devices 102 running the present application, according to a preferred embodiment of the present invention. The server 104 includes similar components as any normal server or a computer, which includes a processor 122, a storage unit 124, a memory unit 126, a communication unit 128, an input/output (I/O) means 130 and a display means 132. The server 104 is in communication with the electronic communication devices 102 in real-time, over the Internet, enabled by the communication unit 128. In some instances, the server 104 is installed with a user management application configured to manage the operations of the present application for managing the workplace allocation and reservation of the available workspaces in a commercial establishment running on the electronic communication devices 102. The user management application is stored in the storage unit 124 and the processor 122, when required, executes the instructions of the user management application. The memory unit 126 stores the data associated with the user management application when the processor 122 executes the instructions of the application. The user management application includes a user management module that handles all the information related to the user registration and all other user related activities performed by the users through the present application for managing the workplace allocation and reservation of the available workspaces in a commercial establishment running on the user's electronic communication devices 102. The user management application running on the server 104 further includes a content management module that receives and temporarily or permanently stores the contents to be presented through the dynamic graphical user interface of the application running on the electronic communication devices 102. The content management module manages the contents and the responses or reactions on each of the contents by the users provided through the present application running on the electronic communication devices 102. In some instances, the user management application running on the server 104 is in communication with a chat server, which manages the real-time chats between the users through the present application. In some other instance, the chat server and the server 104 are the same device, offering social media and instant chat services to the users through the present application.

The users can download the present application from Internet sources including, but not limited to, iTunes® store or App store, Google® Play Store and many other software stores and install the application in their electronic communication devices 102 such as Smartphones. In some instances, different versions of the present application are available from the Internet sources, each version is configured to optimally run on different electronic communication devices 102 such as tablet, smartphone, smart wearable device, desktop and laptop computers, etc., and the users can select and download the desired versions of the application into their electronic communication device 102. After downloading and installing the application, the users can launch the application from the electronic communication device 102 and view the dynamic graphical user interface, which allows the users to perform a number of tasks such as, but not limited to, user registration, online social media platforms integration, search for space for work and other tasks, etc.

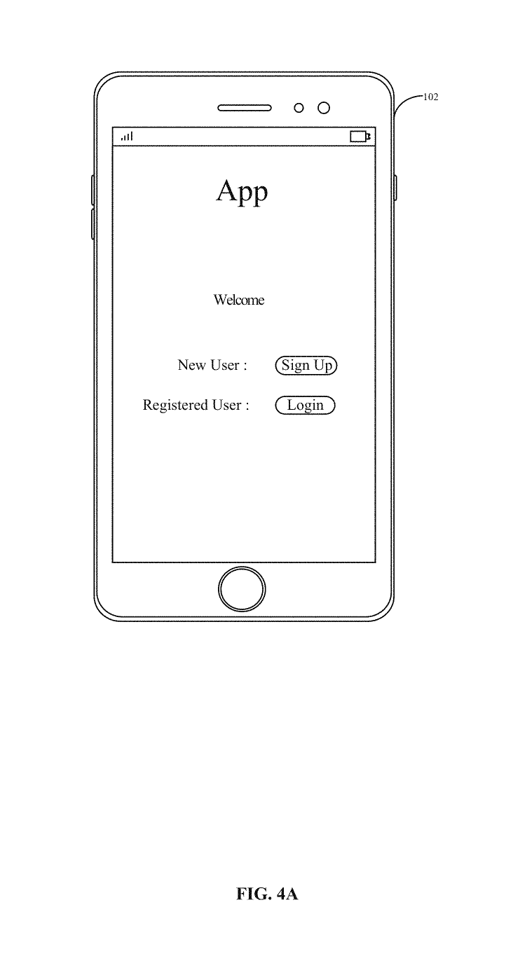

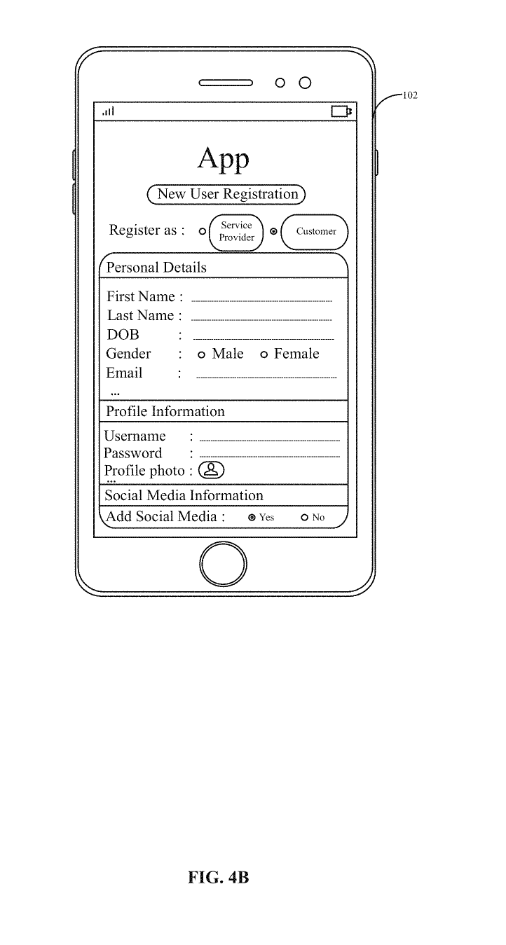

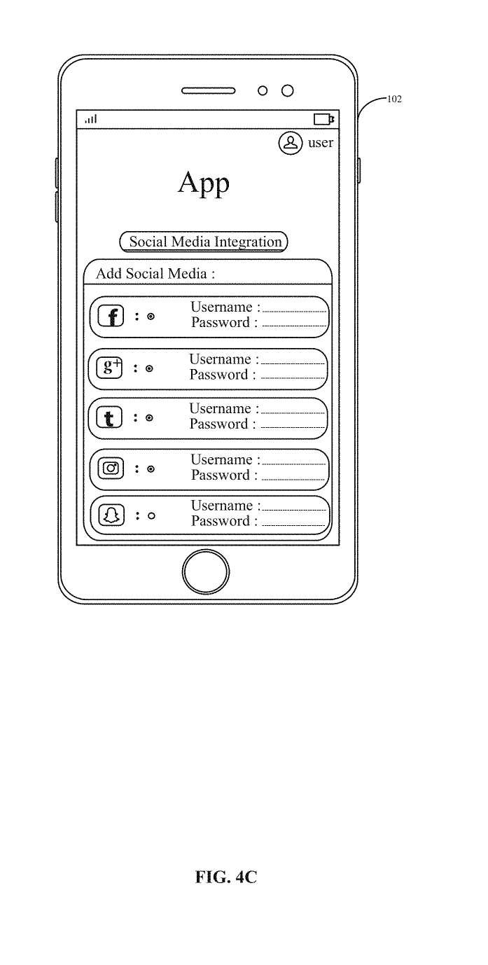

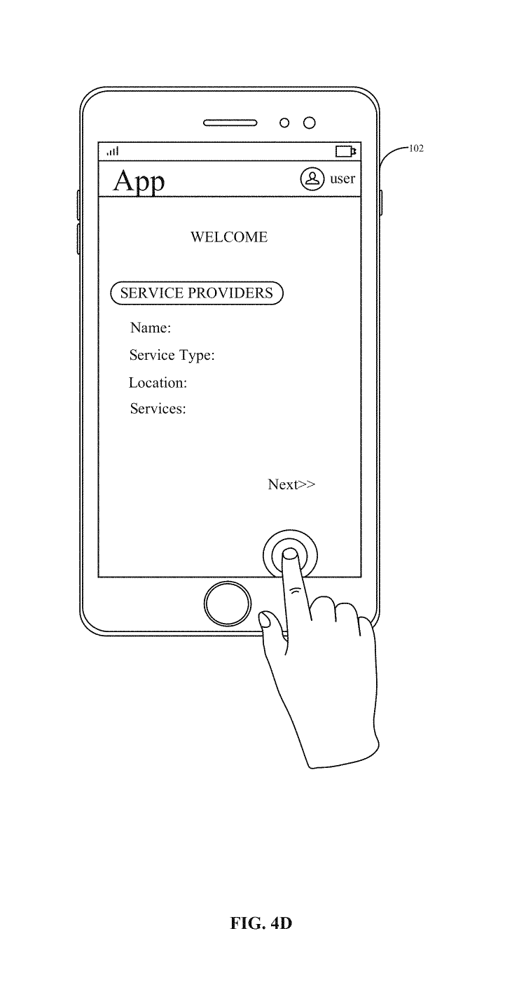

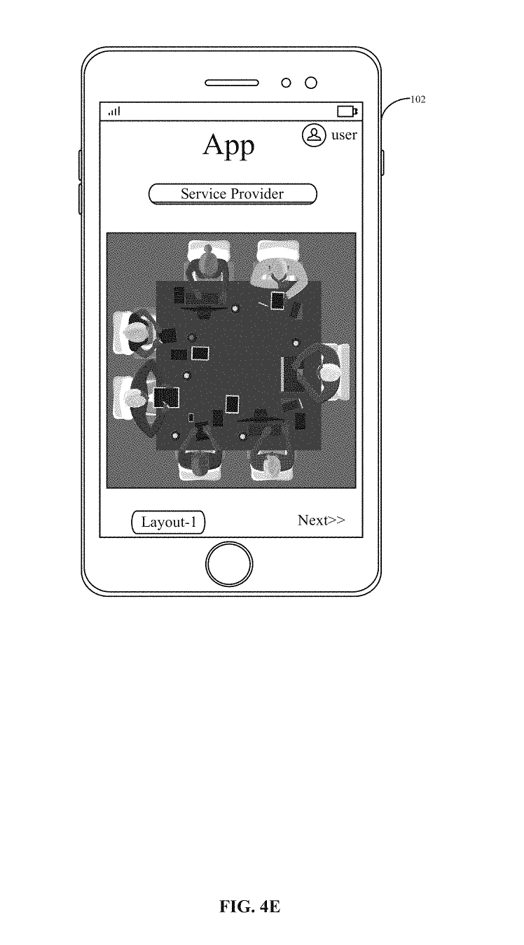

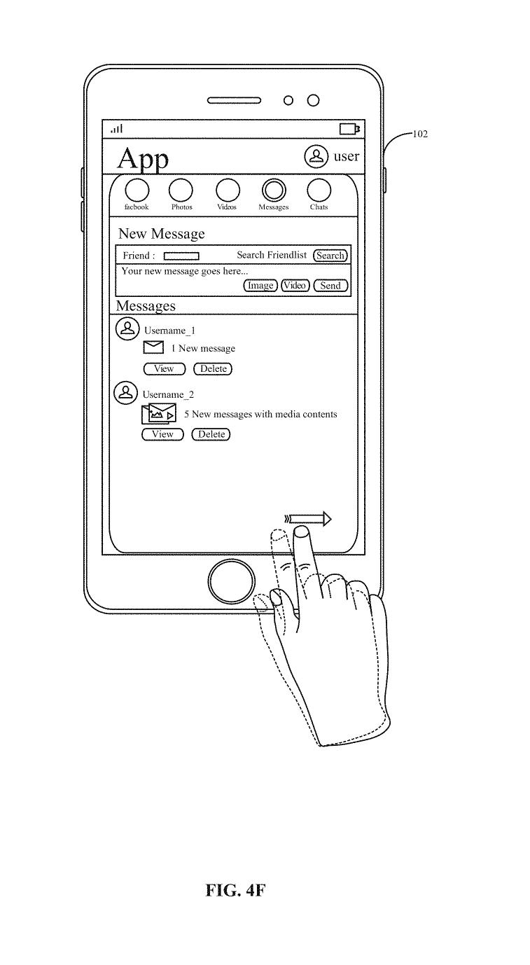

FIG. 4A to FIG. 4F illustrates the representative dynamic graphical user interfaces of the present application for managing the workplace allocation and reservation of the available workspaces in a venue comprising at least one of a commercial establishment, private residence and private property running on the electronic communication device 102, according to one or more embodiment of the present disclosure. The designs of the different versions of the dynamic graphical user interface of the present application may differ from the sample illustrations shown in FIG. 4A to FIG. 4D.

FIG. 4A represents a welcome page of the present application launched on the electronic communication device 102, according to an embodiment of the present disclosure. The welcome page of the application provides necessary details about the application and an introduction video or introduction slides to guide the users (service providers and customers) how to use the application or the features of the application. In some instance, the welcome page of the application launched on the electronic communication 102 device of the user prompts the new users to register into the application and prompts the existing users to log into the application using unique credentials provided to the existing users during their registration. FIG. 4B represents the registration or sign up page of the present application, according to an embodiment of the present disclosure. The registration or sign up page of the application prompts the users to enter their personal details, such as, name, age, contact information, preferences, etc. and also allows the user to upload one or more profile pictures. Once the user completes the registration, he/she will be provided a unique username and password or allowed to select a desired username and password for logging into the application.

In a preferred embodiment, the application allows the users to register as a service provider or a customer. The restaurants, café's, hotels, hangout places, office spaces, and other commercial establishments and private residences and property offering working, other work related and hangout places, etc. can select the option of ‘service provider’ during the registration process through the dynamic graphical user interface of the application. Others looking for a space to work, hangout and other professional or personal engagements can select the ‘customer’ option from the dynamic graphical user interface of the application, as in FIG. 4B. The users can register into the application by providing the necessary details through the dynamic graphical user interface of the application. However, the details requested from the service providers and the customers will be different. For example, the service providers may have to provide the location of their restaurants, cafe's, hotels, hangout places, office spaces, or other commercial establishments and private residences and property, etc., features offered to the customers, etc., whereas the customers need to provide only their personal and professional details, if necessary.

In some embodiment, after completing the user registration process, as shown in FIG. 4B, the application directs the users to an online social media platforms integration page, as is shown in FIG. 4C. From the online social media platforms integration page, the users are allowed to select or add the online social media platforms including, but not limited to, Facebook®, Twitter®, Google Plus®, Instagram®, Snapchat®, YouTube® and other online content sharing, social networking and instant messaging applications where the users having existing accounts. The users can select the desired online social media platforms and enter the user credentials for each of the online social media platforms through the graphical user interface of the present application. After linking the desired online social media platforms, the user can view contents of him/her published through the online social media platforms, the contents published by other users, whom the user follows or subscribed to, and the contents publicly shared by other users.

FIG. 4D is a representative illustration of the user interface of the users registered as ‘service providers’ in the application for managing the workplace allocation and reservation of the available workspaces in commercial establishments and private residences and property, according to a preferred embodiment of the present invention. The dynamic graphical user interface of the application allows the service providers to provide a number of data including business name, title, location and type of the commercial establishment and private residences and property, services offered to the customers, operating hours, layout of the seating arrangements, specialized offers and real-time status of the available space for the customers. The application provides a graphical interface for the service providers, which allows them to provide a layout of the seating arrangement in the commercial establishment and private residences and property, such as the HoReCa, i.e. Hotels, Restaurants, Cafes, office spaces, hangout places and other commercial places and private residences and property offering space to the customers for work, meeting, dining and other purposes. FIG. 4E is a representative illustration of the user interface for providing the layout of the seating arrangement in the commercial establishments and private residences and property, according to a preferred embodiment of the present invention. In some instance, the dynamic user interface of the application allows the service providers to drag and drop the seating arrangement positions. In some other cases, the application allows the users to dynamically update the occupancy or vacancy status of the seating arrangements already listed in the application through the dynamic user interface of the application. Further the application can be linked to the restaurant seating or ordering management applications through application programming interfaces or API's for easy and dynamic real-time update of the seating arrangements and the occupancy status of the seating arrangements. The updated information is instantly reflected in the application launched or accessed by other users or customers and in turn helps the restaurant owners or service providers to effectively manage the booking from the customers. In some other instances, the application allows the users to access the camera of the electronic communication device 102 to capture a picture of the seating arrangement of or the facilities provided by the commercial establishment and private residences and property. The capture image or videos can be uploaded to the commercial establishment's posting or profile information. Further the service providers are also allowed to publish or announce special offers to all the customers or selected customers or customers in a certain geographical area through the application. Further, the service providers such as the HoReCa owners and other office space renting agencies or owners and others providing similar services (e.g. and private residences and property) can advertise their service through the present application. In some instances, the application allows free and paid advertisements for the service providers and also delivers the promotional offers in the form of push notifications through the application or else through short messages, emails or other forms of online advertising methods, such as, but not limited to, through social media platform associated with the present application and through the social media platform of the service providers. In some embodiment, the application allows the service providers to advertise their available space, amenities and other services offers in form of text, images or video formats through the application and other social media platforms associated or linked with the present application.

FIG. 4F is a representative illustration of the user interface of the users registered as ‘customers’ in the application for managing the workplace allocation and reservation of the available workspaces in commercial establishments, according to a preferred embodiment of the present invention. The customers can also link their social media accounts to the present platform, as described earlier. The dynamic graphical user interface of the application accessed from the electronic communication device 102 of the user or the customer allows them to search for available spaces associated with commercial establishments and private residences and property for work and other professional engagements. The customers can also search for nearby commercial establishments and private residences and property for work related and other matters such as meeting, hangouts, dining etc. The dynamic graphical user interface of the application allows the users to provide a variety of information to search for available spaces at a desired commercial establishment, where the information include desired location of the commercial establishment, desired duration and date of use, number of spaces required, additional services including food, beverages, internet connectivity options, location of seating space in the commercial establishment, etc. The application runs on the device 102 communicates with the GPS module of the device to get a proper location information of the customer and assist to get a list of commercial establishments within a certain range or radius of the customer. The users or the customers can select the desired radius or area within which he/she needs to check the availability of spaces for work and other purposes such as meeting, hangouts, dining etc. in a commercial establishment. The application lists all the registered commercial establishments, which includes restaurants, hotels, cafes, office spaces, hangout places, and other commercial entities offering space for hangout, meetings, dining, working and other personal and professional engagements, satisfying the customer's search criteria or requirement entered through the dynamic graphical user interface of the application.

Further the customers can search for the available spaces for extended hours working and professional engagements within an area of interest through the dynamic graphical user interface of the application. In addition, the dynamic graphical user interface of the application allows the users to view a dynamic location map and the available spaces in commercial establishments for work, meetings, dining and other personal and professional engagements. The application allows the customers to view or receive a variety of promotional offers in form of push notifications and advertisements through the graphical user interface of the application. The service providers lists a variety of profitable deals for the users, where the deal is automatically adjusted for price and other service offerings based on factors including customer demand, time, duration of use, date of use, and other external factors. The application allows the customers to view, select and compare such deals and offers from the commercial establishments within the dynamic graphical user interface of the application. Further the users can also view the layout of the available space in the commercial establishment, book the space for a predetermined date and for a predetermined duration and book a number of other services from the commercial establishment through the dynamic graphical user interface of the application. The user or the customer receives notifications in form of messages, emails and through other social media or other communication means upon successful booking through the application. The application also allows the users to provide feedbacks to the booking through the dynamic graphical user interface of the application before and after visiting the place.

In some embodiment, the application enables social connections between the members of the application. The application forms a social networking platform to connect the users registered to the application and allows sharing information such as work related, professional information, personal information and other booking related information through the dynamic user interface of the application. The application also allows the users to add friends or connections among the members or registered users of the application and provides instant chat, real-time image, video and other data sharing, booking information sharing, sending invites for the meetings etc. Further the application also allows the users to contact nearby users resisted to the application with the assistance from the GPS module of the electronic communication device 102. The application interacts with the GPS module of the electronic communication device 102 to allow the users to share his/her location through the dynamic graphical user interface to notify and invite others for the work, meetings, hangouts, etc. at a selected commercial establishment etc. Moreover, the application allows the users to share information about his/her activity at the commercial establishment and private residences and property to notify and invite others through the application. This information includes location, project and work details, meeting topics, and other relevant information on the activity performed at the commercial establishment by the user or the customer. In addition, the application allows the users to share his/her location and other workrelated details or tasks performed at the commercial establishment through other social media platforms including Facebook®, Twitter®, Instagram®, etc. The application allows the users to form social connections through the dynamic graphical user interface to share information and to enable personal and professional interactions and allows the users to communicate with other users through a real-time chat feature or window through the dynamic graphical user interface of the application. In some embodiment, the application allows the users to change his/her visibility to other users through the dynamic graphical user interface of the application, i.e. the customer or the user can set his/her status to visible, invisible, busy, available for chat etc. through the dynamic user interface of the application. The application also allows the users to receive rewards and loyalty points for expanding and forming new social connections through the dynamic graphical user interface of the application. The rewards and loyalty points earned through the application can be redeemed at the commercial establishments for food, beverage, priority seats, cash discounts etc.

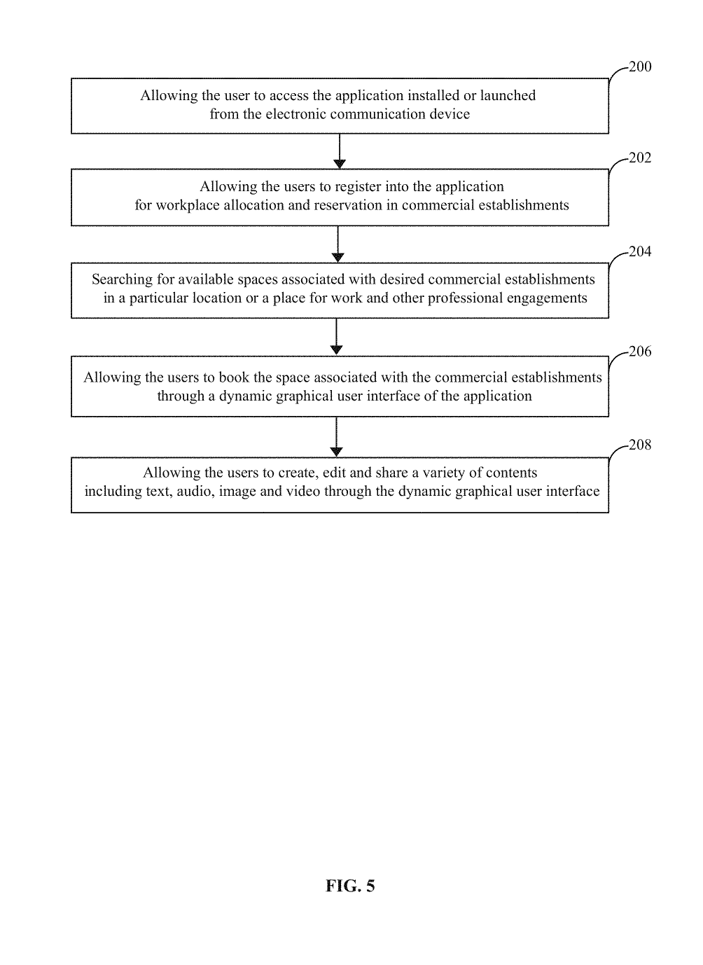

FIG. 5 is a flowchart showing the steps for a customers to perform bookings in a commercial establishment through the application for workplace allocation and reservation in commercial establishments, according to a preferred embodiment of the present invention. The method starts with the step of allowing the user to access the application installed or launched from the electronic communication device 102, as in block 200. The users are then allowed to register or login to the application as in block 202. The user can then search for available spaces associated with desired commercial establishments in a particular geographic location (e.g. zip code) or a place for work (address and range of miles from the address) and other professional engagements, and services provided (e.g. free Wi-Fi and power outlets) as in block 204. Then as in block 206, the users can book the space for a specific date and time associated with the commercial establishments and private residences and property through a dynamic graphical user interface of the application. Once the booking has been successful, then the customer and the service provider receive the notifications and can communicate through the application. In an additional embodiment, the customer can also share the booking details through social media and through the application to invite others or to share with people to get similar minded people to join them during the booking time and at the venue.

Further, it should be noted that the steps described in the method of use can be carried out in many different orders according to user preference. The use of “step of” should not be interpreted as “step for”, in the claims herein and is not intended to invoke the provisions of 35 U.S.C. § 112, paragraph 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A computer implemented system for assisting a plurality of service providers and a plurality of customers to perform workplace allocation and reservation in a commercial establishment, and private residence and property, comprising:
an electronic communication device having at least one processor to execute a plurality of instructions of an application configured to:
enable the plurality of service providers to publish a plurality of available spaces within each of a commercial establishment, and private residence and property, for utilization by customers;
allow the plurality of customers to request at least one space associated with the commercial establishment, or private residence and property, at a predetermined date for a predetermined period of time;
wherein the at least one space is utilized in the form of a workplace;
at least one server running at least one server-side application associated with the application running on the electronic communication device;
a wireless and/or wired communication network for enabling communication between the server and the electronic communication device; and
characterized in that the application running on the electronic communication device allows the service providers to publish the available spaces for viewing in real-time by customers through a dynamic graphical user interface of the application

2. The computer implemented system of claim 1, wherein the application for booking the plurality of spaces associated with the commercial establishments, and private residences and properties, is available to the customers in the form of a mobile application, a web application and a cloud-based application,
wherein the application accessed from the electronic communication devices allows the customers to search for the plurality of available spaces associated with the commercial establishments and private residences and properties for desk and computer work and professional meetings, interviews, and presentations.

3. The computer implemented system of claim 1, wherein the dynamic graphical user interface of the application allows the service providers to provide a plurality of information to search for the plurality of available spaces at a desired commercial establishment, and private residence and property,
wherein the plurality of information includes:
a desired location of the commercial establishment;
a desired duration and date of use;
a number of workspaces required;
a plurality of additional services including a food, beverages, a plurality of connectivity equipment including Wi-Fi devices and other wired connectivity devices and other types of office and computer equipment for utilization; and
a location of a seating space in the commercial establishment and/or private residence and property.

4. The computer implemented system of claim 1, wherein the plurality of commercial establishments includes restaurants, hotels, cafes, office spaces, hangout places, and other commercial entities offering spaces for computer work, desk work, professional meetings, interviews, and presentations and professional meals or drinks.

5. The computer implemented system of claim 1, wherein the dynamic graphical user interface of the application allows a user to register as a customer or as a service provider.

6. The computer implemented system of claim 5, wherein the dynamic graphical user interface of the application allows the service providers to provide a plurality of data including:
at least one location of the commercial establishment, private residence or property;
a plurality of services offered to the customers;
at least one layout of the seating arrangement;
a plurality of specialized offers; and
a real-time status of the available space for the customers.

7. The computer implemented system of claim 5, wherein the customers can search for the available spaces offering extended working hours within a geographic area of interest, or by address, through the dynamic graphical user interface of the application.

8. The computer implemented system of claim 1, wherein the dynamic graphical user interface of the application allows the customers to view a dynamic location map and the available spaces in commercial establishments, and private residences and properties, for office and computer work, meetings, interviews, dining and other personal and professional engagements.

9. The computer implemented system of claim 1, wherein the application allows the service providers to provide a plurality of profitable deals for the users in a form of push notifications and advertisements,
wherein the plurality of profitable deals are automatically adjusted for price and other service offerings based on a plurality of factors including customer demand, time, duration of use, date of use, and other external factors.

10. The computer implemented system of claim 1, wherein the application allows the user-customers to search for spaces in commercial establishments, and private residences and properties, at a desired location, compare a plurality of deals for the spaces, view layout of the space in the commercial establishment, book the space for a predetermined date and for a predetermined duration and book a plurality of services from the commercial establishment.

11. The computer implemented system of claim 1, wherein the application forms a social networking platform to connect a plurality of customers registered to the application,
wherein the application allows the customers to form social connections through the dynamic graphical user interface to share the plurality of information and to enable personal and professional interactions.

12. The computer implemented system of claim 1, wherein the application interacts with a GPS module of the electronic communication device to allow the customers to share his/her location through the dynamic graphical user interface to notify and invite others.

13. The computer implemented system of claim 1, wherein the application allows the customers to share a plurality of information regarding his/her activity at the commercial establishment, private residence or property, to notify and invite others,
wherein the plurality of information includes location, project and work details, meeting topics, and other relevant information on the activity performed at the commercial establishment, or the private residence and property.

14. The computer implemented system of claim 1, wherein the application allows the customers to communicate through a real-time chat window displayed through the dynamic graphical user interface of the application.

15. The computer implemented system of claim 1, wherein the application allows the customers to provide feedbacks and receive rewards and loyalty points for expanding and forming new social connections through the dynamic graphical user interface of the application,
wherein the rewards and loyalty points earned through the application can be redeemed at the commercial establishments, and private residence and property.

16. The computer implemented system of claim 1, wherein the electronic communication device running the application is selected from a group consisting of smartphones, tablets, laptop, desktop computer, smart wearables devices, and other smart-internet enabled electronic devices.

17. A non-transitory computer readable storage medium containing a plurality of executable instructions for booking reservations for workspaces in at least one of a commercial establishment, and private residence and property, the executable instructions includes instructions for:
publishing by a plurality of service providers on a wireless network a plurality of seating locations in a commercial establishment, and a private residence and property, of the service providers;
accepting reservations of the commercial establishments, and the private residences or and properties, made by a customer utilizing an electronic computing device,
wherein the executable instructions of the application being processed using a processor associated with the electronic communication device allows the users to register in a form of a service provider for publishing a plurality of information related to the at least one commercial establishment, and private residence and property, wherein the plurality of information includes:
at least one location of the commercial establishment, and a private residence and property;
a plurality of services offered to a plurality of customers;
a layout of at least one seating arrangement associated with the commercial establishment, and a private residence and property;
a plurality of specialized offers to the customers; and
a real-time status of a plurality of available spaces for the customers;
wherein the executable instructions of the application being processed using the processor associated with the electronic communication device allows the customers to launch the application from within the electronic communication devices and register in the form of a customer;
wherein the application allows the customers to:
search for the plurality of available spaces associated with the commercial establishments, and the private residence and property, for desk, office, and/or computer work, and professional engagements comprising meetings, dining, interviews and presentations; and
book at least one space associated with the commercial establishments, and the private residences or properties, through a dynamic graphical user interface of the application.

18. The non-transitory computer readable storage medium of claim 17, wherein the application running on the electronic communication devices allows the customers to navigate through a dynamic graphical user interface for accessing a plurality of features of the application,
wherein the plurality of features includes:
a list of the plurality of commercial establishments, and private residences and property offering the spaces and equipment for work related and other professional engagements comprising professional meetings, interviews, presentations and professional meals or drinks;
a plurality of services offered by the commercial establishments at a desired location; and
a plurality of dynamic interactive visualizations of the plurality of spaces associated with commercial establishments, and a private residences and properties, and a plurality of options to view and select a desired space from a plurality of layouts of the available spaces offered by the commercial establishments, and a private residences and properties.

19. A computer implemented method for assisting at least one service provider and customer to perform workplace allocation and reservation in a commercial establishment, and a private residence and property, comprising the steps of:
publishing by at least one service provider electronic communications device on a wireless network information on a plurality of seating locations in a commercial establishment, and/or a private residence and property, of the service provider, wherein the information comprises,
at least one location of the commercial establishment, and a private residence and property;
a plurality of services offered to a plurality of customers;
a layout of at least one seating arrangement associated with the commercial establishment, and the private residence and property;
a plurality of specialized offers to the customers;
a real-time status of a plurality of available spaces for the customers;
receiving at least one reservation of at least one of the commercial establishments, and private residences and properties, via the wireless network by a customer electronic communications device, by allowing the customer to:
search for the plurality of available spaces associated with the commercial establishments, and the private residences and properties, for work and other professional engagements comprising professional meetings, interviews, and presentations and professional meals or drinks; and
book at least one space associated with the commercial establishments, and private residences and properties, through a dynamic graphical user interface of the application.

20. The computer implemented method of claim 19, further comprising allowing the customer to view before booking:
a list of the plurality of commercial establishments, and private residences and properties, offering the spaces and equipment for work related and the other professional engagements;
a plurality of services offered by the commercial establishments, and private residences and properties, at a desired location; and
a plurality of dynamic interactive visualizations of the plurality of spaces associated with commercial establishments, and private residences and properties, and a plurality of options to view and select a desired space from a plurality of layouts of the available spaces offered by the commercial establishments, and private residences and properties.
